(19) United States
(12) Patent Application Publication
(10) Pub. No.: US 2020/0343786 A1
(43) Pub. Date: Oct. 29, 2020

(54) PACKAGING STRUCTURE FOR A MOTOR CASING

(71) Applicant: Kenneth CHUANG, Taipei (TW)

(72) Inventor: Kenneth CHUANG, Taipei (TW)

(21) Appl. No.: 16/391,759

(22) Filed: Apr. 23, 2019

(51) Int. Cl. H02K 5/26; F16B 23/00

(52) U.S. Cl. CPC H02K 5/26; F16B 23/0084

(57) ABSTRACT

A packaging structure for a motor casing, comprising an upper cover, a lower cover and a flange, wherein the upper cover and the lower cover are separately located over two sides of a motor spindle, the upper cover and the lower cover are combined into the motor casing for receiving a rotor, a stator, a bearing and a control circuit board of a motor, the upper cover and the lower cover are fastened by at least one first bolt, the first bolt passes through the upper cover in a radial direction of the motor to screw into a threaded hole of the lower cover, the first bolt evades positions of both the rotor and the stator, the flange is a circular member which binds a front end of the combined upper cover and lower cover, and the flange is fastened onto the front end of both the upper cover and lower cover by second bolts.

### TECHNICAL FIELD

The invention relates to structures of DC motors, particularly to casings of brushless DC motors.

### RELATED ART

Brushless DC electric motor (BLDC motors, BL motors) also known as electronically commutated motors (ECMs, EC motors), or synchronous DC motors, are synchronous motors powered by DC electricity via an inverter or switching power supply which produces an AC electric current to drive each phase of the motor via a closed loop controller. The controller provides pulses of current to the motor windings that control the speed and torque of the motor. Simply speaking, the commutation is a process of switching the phase of motor current to generate kinetic energy. A brush motor has an actual brush which can complete double of the above process, but a BLDC motor has no brush.

In comparison with conventional brush motors, the BLDC motors can increase efficiency by 15-20%, do not need periodic maintenance (no wearing of brush) and can obtain flat torque curves at all rated speeds. Because of progress of semiconductor technology, quality improvement of permanent magnet and requirements of DC motors with high efficiency, the BLDC motors have replaced conventional brush motors in many applications to be applied to various fields such as cars, aviation, consumer electronics, medical supplies, industrial automation and instruments.

To obtain better efficiency than brush motors, a very precision control circuit must be used between a BLDC motor and a controller. The controller has to detect an accurate position of the stator against the rotor at all times so as to precisely control the motor. Known detection approaches include using a Hall effect sensor, an encoder or a resolver. The sensor is usually disposed in a casing of a BLDC motor, for example, an end of a spindle of a rotor. For those BLDC motors utilized in precision machines, the sensor must be precisely aligned with a rotor of a BLDC motor. This must be implemented by an experienced engineer in a manual manner, so it is complicated and time consuming.

Usually, currently available motor casings are of a cylindrical shape. When these motors which such a shape are being assembled in a production line or implemented with adjustment or maintenance in use, the rotors, bearings and controllers (or control circuit boards) in the motors must be disassembled in the axial direction of the motor. Each disassembly may affect accuracy of the abovementioned parts, even cause wear and tear. Also, precision positioning of the sensor is difficult to perform.

### SUMMARY OF THE INVENTION

An object of the invention is to provide a packaging structure for a motor casing, which is easy to be assembled and to adjust a relative position between the control circuit board and the rotor.

To accomplish the above object, the packaging structure for a motor casing of the invention includes an upper cover, a lower cover and a flange. The upper cover and the lower cover are separately located over two sides of a motor spindle. The upper cover and the lower cover are combined into the motor casing for receiving a rotor, a stator, a bearing and a control circuit board of a motor. The upper cover and the lower cover are fastened by at least one first bolt. The first bolt passes through the upper cover in a radial direction of the motor to screw into a threaded hole of the lower cover. The first bolt evades positions of both the rotor and the stator. The flange is a circular member which binds a front end of the combined upper cover and lower cover. The flange is fastened onto the front end of both the upper cover and lower cover by second bolts.

Preferably, both the upper cover and the lower cover are made of metal.

Preferably, both the upper cover and the lower cover are formed with a trough structure corresponding to the stator, the bearing and the control circuit board.

### BRIEF DESCRIPTION OF THE DRAWINGS

FIG. 1 is an assembled view of packaging structure of a motor casing of an embodiment of the invention;

FIG. 2 is an exploded view of packaging structure of a motor casing of an embodiment of the invention;

FIG. 3 is a cross-sectional view of the upper cover;

FIG. 4 is a left view of FIG. 3;

FIG. 5 is a cross-sectional view of the lower cover;

FIG. 6 is a left view of FIG. 5; and

FIG. 7 is a longitudinally sectional view of the brushless DC motor of the invention.

### DETAILED DESCRIPTION OF THE INVENTION

In the following description, the terms “upper”, “lower”, “left” and “right” are based on the directions shown in the figures if no particular indication.

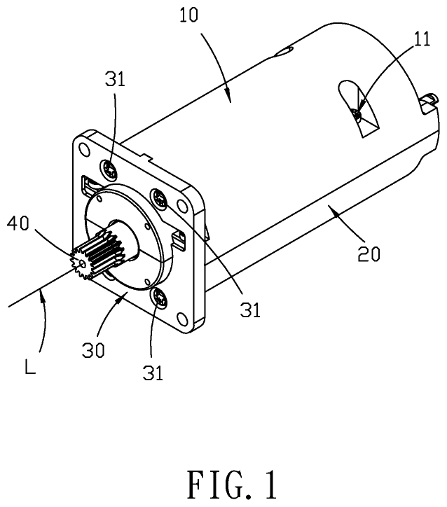

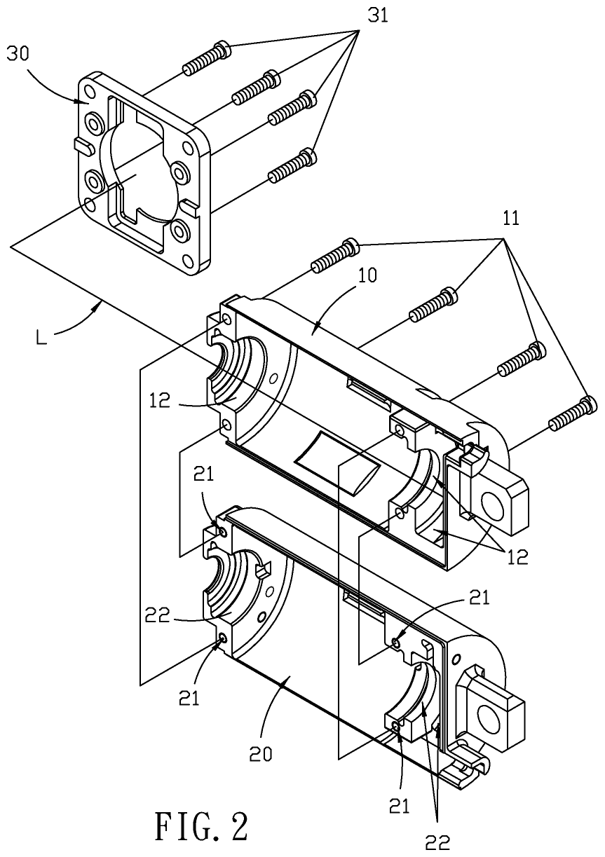

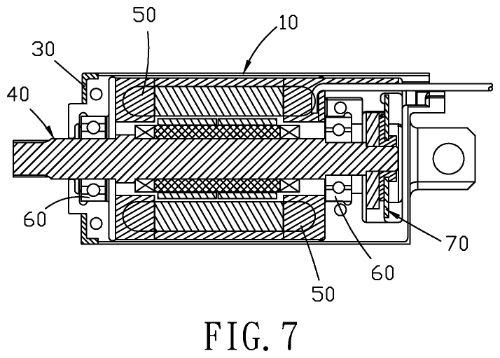

Please refer to FIGS. 1 and 2, which are an assembled view and an exploded view of packaging structure of a motor casing of an embodiment of the invention, respectively. The packaging structure for a motor casing of the invention includes an upper cover 10, a lower cover 20 and a flange 30. The upper cover 10 and the lower cover 20 are separately located over two sides of a motor axis L. The upper cover 10 and the lower cover 20 are combined into the motor casing for receiving a rotor 40, a stator 50, a bearing 60 and a control circuit board 70 (see FIG. 7).

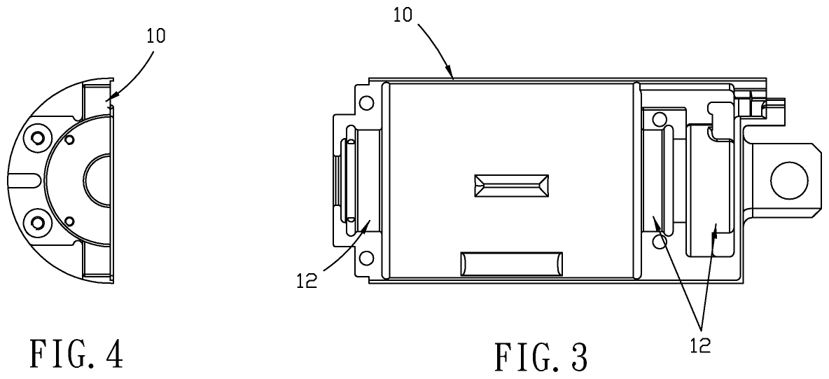

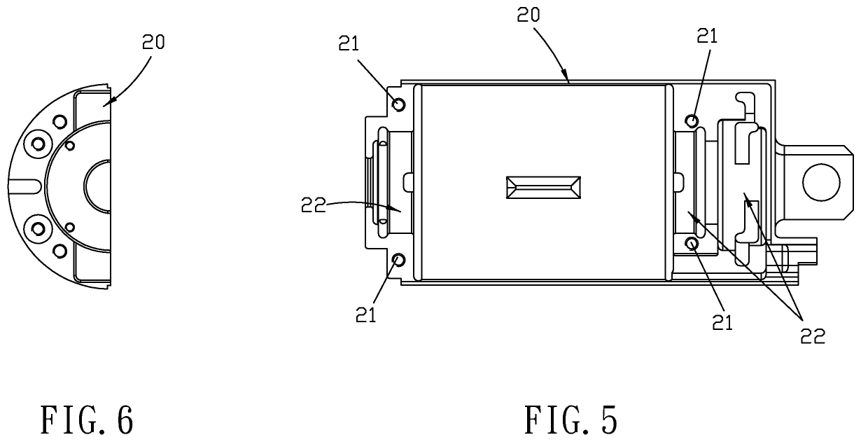

As shown in FIG. 1, the upper cover 10 and the lower cover 20 are fastened by at least one first bolt 11. The first bolt 11 passes through the upper cover 10 in a radial direction of the motor to screw into a threaded hole 21 of the lower cover 20. The first bolt 11 evades positions of both the rotor 40 and the stator 50. In a preferred embodiment, both the upper cover 10 and the lower cover 20 are made of metal to form a firm motor casing. Please refer to FIGS. 3-6. An embodiment of both the upper cover 10 and the lower cover 20 is of a cylindrical shape. Both the upper cover 10 and the lower cover 20 are formed with a trough structure 12, 22 corresponding to the stator 50, the bearing 60 and the control circuit board 70.

The flange 30 is a circular member which binds a front end of the combined upper cover 10 and lower cover 20 (see FIG. 1). The flange 30 is fastened onto the front end of both the upper cover 10 and lower cover 20 by second bolts 31.

The packaging structure of the invention adopts a side-by-side type. When assembling, repairing or adjusting, only remove the flange 30 and the first bolt 11 first, both the upper cover 10 and the lower cover 20, which constitute the casing of the motor, can be directly separated in a radial direction of the motor. Even, the relative position between the control circuit board 70 and the rotor 40 can be adjusted without removing the bearing 60. Thus, assembly, repair and adjustment can be easily implemented.

It will be appreciated by persons skilled in the art that the above embodiment has been described by way of example only and not in any limitative sense, and that various alterations and modifications are possible without departure from the scope of the disclosed example as defined by the appended claims.

What is claimed is:

1. A packaging structure for a motor casing, comprising an upper cover, a lower cover and a flange, wherein the upper cover and the lower cover are separately located over two sides of a motor spindle, the upper cover and the lower cover are combined into the motor casing for receiving a rotor, a stator, a bearing and a control circuit board of a motor, the upper cover and the lower cover are fastened by at least one first bolt, the first bolt passes through the upper cover in a radial direction of the motor to screw into a threaded hole of the lower cover, the first bolt evades positions of both the rotor and the stator, the flange is a circular member which binds a front end of the combined upper cover and lower cover, and the flange is fastened onto the front end of both the upper cover and lower cover by second bolts.

2. The packaging structure of claim 1, wherein both the upper cover and the lower cover are made of metal.

3. The packaging structure of claim 1, wherein both the upper cover and the lower cover are formed with a trough structure corresponding to the stator, the bearing and the control circuit board.
